(19) United States
(12) Patent Application Publication
(10) Pub. No.: US 2007/0154779 A1
(43) Pub. Date: Jul. 5, 2007

(54) Porous carbon electrode substrates and methods for preparing the same

(75) Inventors: Tse-Hao Ko, Taichung (TW); Yuankai Liao, Taichung (TW); Ching-Han Liu, Taichung (TW); Ming-Chian Hung, Taichung (TW)

Correspondence Address: Venable LLP;Raymond J. Ho, 575 7th Street NW, Washington, DC, 20004-1601, US

(73) Assignee: FENG CHIA UNIVERSITY, Taichung (TW)

(21) Appl. No.: 11/437,773

(22) Filed: May 22, 2006

(30) Foreign Application Priority Data
Jan. 4, 2006 (TW) 095100284

(51) Int. Cl. H01M 4/96

(52) U.S. Cl. 429/44

(57) ABSTRACT

The present invention relates to a porous carbon electrode substrate with a woven structure and having a property combination of a thickness ranging from 0.1 to 1.0 mm, a bending strength of 0.7 MPa or more, a porosity of 50% or more, and a surface resistivity of 1.0 Ω/sq or less. The present invention also relates to a method of preparing a porous carbon electrode substrate comprising the following steps: (a) providing an oxidized fabric or pre-carbonized oxidized fabric, (b) impregnating the fabric with a resin to provide a resin material-carried fabric, (c) heating and pressing the resin material-carried fabric, and (d) carbonizing the heated and pressed fabric.

### CROSS-REFERENCES TO RELATED APPLICATIONS

This application claims priority to Taiwan Patent Application No. 095100284 filed on Jan. 4, 2006.

### STATEMENT REGARDING FEDERALLY SPONSORED RESEARCH OR DEVELOPMENT

Not applicable.

### BACKGROUND OF THE INVENTION

1. Field of the Invention

The present invention relates to a porous carbon electrode substrate, particularly to an electrode substrate for use in a solid polymer fuel cell or a direct methanol fuel cell. The present invention also relates to a method for preparing the porous carbon electrode substrate.

2. Descriptions of the Related Art

As compared with the electrodes for use in phosphoric acid fuel cells, porous carbon electrodes for solid polymer fuel cells or direct methanol fuel cells need to be gas- and liquid-diffusible and permeable, electrically conductive, and flexible, as well as durability and pressing strength for assembling cells. Furthermore, to meet the miniaturization requirement, porous carbon electrodes for a solid polymer cell or a direct methanol fuel cell are normally prepared as sheet-like or paper-like electrodes to reduce the total volume of cell.

Porous carbon electrodes for solid polymer fuel cells or direct methanol fuel cells are conventionally prepared by wet papermaking methods. In a wet papermaking method, short carbon fibers are subjected to the papermaking process, thermosetting resin impregnation, curing process, and high temperature carbonization treatment. Since a uniform dispersion of carbon fibers can hardly be achieved during the pulp forming procedure of the papermaking process, it is difficult to produce carbon fiber papers with a uniform distribution of carbon fibers. Therefore, the void content of the carbon fiber papers is normally too high to provide electrodes with satisfied electric conductivity. The non-uniform carbon fiber distribution also causes non-uniform thickness and non-uniform electric conductivity.

With respect to the aforementioned problems, JP 07-142068 A (1995) discloses mixing carobonaceous milled fibers to provide a modified porous carbon electrode substrate. However, the electrode substrate prepared thereby is too thick to be flexible enough for use in a solid polymer fuel cell. JP 09-157052 (1997) discloses another porous carbon sheet and its preparation method. Similarly, the electrode prepared here is too low in density to provide satisfied electric conductivity.

U.S. Pat. No. 6,713,034 B2 (2004), corresponding to Taiwan (ROC) Patent Publication No. 489544, discloses porous carbon electrode substrates for fuel cells and methods for manufacturing the electrode substrates. The method disclosed in U.S. Pat. No. 6,713,034 B2 (2004) utilizes a wet papermaking technology. The method comprises deliberating short carbon fibers in water, sufficiently mixing the short carbon fibers with short fibers of polyvinyl alcohol as a binder, and conducting a papermaking step to provide carbon fiber papers. Thereafter, the carbon fiber papers are impregnated with a phenol resin, heated and pressed to cure the resin, and carbonized at a temperature ranging from 1600 to 2000° C. to provide porous electrode substrates. Nevertheless, the porous electrode substrates prepared by the method disclosed in U.S. Pat. No. 6,713,034 B2 (2004) are non-uniform in fiber orientations and tend to be deficient in strength in the direction vertical to the orientation of fibers. Therefore, it is difficult to control the porosity or gas permeability of the porous electrode substrates.

JP 11-185771 A (1999) discloses the use of short, fine carbon fibers as the papermaking material so as to reduce the electric resistance. Because of the difficulty of dispersing the fine carbon fibers during the papermaking procedure, the carbon fiber papers, thus prepared, still have the problem of a non-uniform distribution of carbon fibers. Therefore, it is still difficult to control the porosity or gas permeability of the prepared porous carbon electrode substrates.

In view of the above disclosures, it is apparent that the current technology for preparing porous carbon electrode substrates from carbon fiber papers fails to provide carbon fiber papers with uniform distribution of fibers for the preparation.

The present invention is directed to the aforementioned needs, and provides a porous carbon electrode substrate that has an appropriate combination of void content, electric conductivity, thickness and bending strength and is suitable for use in fuel cells.

### SUMMARY OF THE INVENTION

An object of the present invention is to provide a porous carbon electrode substrate with a woven structure and having a property combination of a thickness ranging from 0.1 to 1.0 mm, a bending strength of 0.7 MPa or more, a porosity of 50% or more, and a surface resistivity of 1.0 Ω/sq or less.

Another object of the present invention is to provide a method of preparing a porous carbon electrode substrate with a woven structure and having a property combination of a thickness ranging from 0.1 to 1.0 mm, a bending strength of 0.7 MPa or more, a porosity of 50% or more, and a surface resistivity of 1.0 Ω/sq or less, comprising the following steps:

(a) providing a fabric that is an oxidized fabric or a pre-carbonized oxidized fabric;

(b) impregnating the fabric with a resin material to provide a resin material-carried fabric;

(c) heating and pressing the resin material-carried fabric; and

(d) carbonizing the heated and pressed fabric.

Yet another object of the present invention is to provide a method of preparing a porous carbon electrode substrate with a woven structure and having a property combination of a thickness ranging from 0.1 to 1.0 mm, a bending strength of 0.7 MPa or more, a porosity of 50% or more, and a surface resistivity of 1.0 Ω/sq or less, comprising the following steps:

(a) providing an oxidized fabric;

(b) pre-carbonizing the oxidized fabric;

(c) impregnating the fabric with a resin material to provide a resin material-carried fabric;

(d) heating and pressing the resin material-carried fabric; and

(e) carbonizing the heated and pressed fabric.

The detailed technology and preferred embodiments implemented for the subject invention are described in the following paragraphs for people skilled in this field to well appreciate the features of the claimed invention.

### DESCRIPTION OF THE PREFERRED EMBODIMENT

The present invention provides a porous carbon electrode substrate with a woven structure and without the shortcoming of being deficient in strength in the direction vertical to the orientation of fibers that is typically common in conventional electrode substrates prepared from short carbon fibers; thus, the porous carbon electrode substrate of the present invention is suitable for use in a solid polymer fuel cell or a direct methanol fuel cell. Specifically, the electrode substrate of the present invention has a property combination of a thickness ranging from 0.1 to 1.0 mm, a bending strength of 0.7 MPa or more, a porosity of 50% or more, and a surface resistivity of 1.0 Ω/sq or less.,

The porous carbon electrode substrate of the present invention can be prepared by a method comprising the following steps:

(a) providing a fabric that is an oxidized fabric or a pre-carbonized oxidized fabric;

(b) impregnating the fabric with a resin material to provide a resin material-carried fabric;

(c) heating and pressing the resin material-carried fabric; and

(d) carbonizing the heated and pressed fabric.

The oxidized fabrics suitable for the present invention typically have a limiting oxygen index of at least 40. The oxidized fabric can be prepared by processes such as, but not limited to, thermally treating a fabric composed of one or more of the following materials: polyacrylonitrile (PAN) fibers, asphalt fibers, phenolic fibers, and cellulose fibers. For example, a suitable oxidized fabric can be prepared by heating a PAN fabric at a temperature ranging from 200° C. to 300° C. in air. Preferably, the oxidized fabric is prepared from a fabric composed of PAN fibers and/or phenolic fibers, most preferably from a PAN fabric prepared from oxidized PAN fibers.

The pre-carbonized oxidized fabric suitable for the present invention can be prepared from a pre-carbonizing oxidized fabric, which typically has a carbon content of 55 wt % or more and a density of more than 1.5 g/cm³. For instance, a pre-carbonized oxidized fabric can be prepared by pre-carbonizing an oxidized fabric that has a limiting oxygen index of at least 40 at a temperature ranging from 600° C. to 3000° C. in a vacuum or with the protection of an inert gas selected from the group consisting of nitrogen, helium, argon, and a combination thereof. Preferably, the pre-carbonization is conducted under a tensionless condition to naturally shrink the oxidized fabric so as to reduce the porosity among fibers and increase the electric conductivity of the electrode substrate prepared from thus obtained pre-carbonized oxidized fabric.

To meet the miniaturization requirement of fuel cells, fabrics used in the present invention preferably have a thickness ranging from 0.1 to 1 mm so as to provide an electrode substrate with an appropriate thickness. If the thickness of fabrics is less than 0.1 mm, the strength in the thickness direction may be insufficient. On the other hand, if the thickness is more than 1 mm, the total thickness of a assembled cell stack becomes too thick to meet actual requirements.

In the impregnation step, the oxidized or pre-carbonized oxidized fabric is impregnated with a resin material to provide a resin material-carried fabric. The resin material forms bridges among the fibers of fabric and enhances the binding among fibers so as to increase the bending strength of final product. The resin material can be a thermosetting resin such as, but not limited to, a phenolic resin, a furan resin, or a combination thereof, or a thermoplastic resin such as, but not limited to, a polyamide resin, a polyimide resin, or a combination thereof. It is appropriate to dissolve the resin material in a solvent and conduct the impregnating step by using a resin solution. For example, in the case of using a phenolic resin, a methanol solution can be prepared by dissolving the phenolic resin in methanol, in which the methanol solution is used for impregnating the oxidized fabric or pre-carbonized oxidized fabric.

The content of the resin material in the oxidized fabric or pre-carbonized oxidized fabric preferably ranges from 0.001 to 50 wt %, more preferably from 0.01 to 40 wt %, and most preferably from 0.02 to 30 wt %. The content refers to the level of resin material in the oxidized fabric or pre-carbonized oxidized fabric after the fabric is subject to a hereinafter described heating and pressing treatment. As described above, the electric conductivity of the resin material after carbonization is inferior to that of carbon fibers. Therefore, from the viewpoints of maintaining the shape of the prepared porous carbon electrode substrate and providing an electrode substrate with the desired electric conductivity, a resin material content ranging from 0.2 to 30 wt % is preferred.

In the hereinafter described carbonization treatment, the fibers in the (pre-carbonized) oxidized fabric will convert to carbon fibers, while most of the resin will be decomposed and volatilized and form voids so as to increase the liquid and gas permeability of the prepared porous carbon electrode substrate.

Optionally, the resin material may contain one or more conductive substances to enhance the electric conductivity of final product. Examples of the conductive substance are, but not limited to, carbon black, acetylene black, graphite powder, carbonaceous milled fiber, isotrophic graphite powder, vapor-grown carbon fiber, nano-carbon tube, mesophase pitch powder, and the like. The level of the conductive substance(s) in the resin material preferably ranges from 0.1 to 50 wt %, more preferably from 0.1 to 20 wt %, based on the total weight of the resin material. If the level of conductive substance(s) is less than 0.1 wt %, it is disadvantageous in that the effect on the conductivity improvement tends to be slight, and if the level exceeds 50 wt %, it is disadvantageous in that the effect on the conductivity improvement tends to be saturated, resulting in an increase in cost.

In the heating and pressing stop, the resin carried by fabrics will cure and sufficiently penetrate the fabrics so as to increase the binding among the fibers of fabrics. It is preferable to batchwise-conduct the heating and pressing step at a temperature ranging from 70° C. to 320° C. and a pressure ranging from 1 to 200 kg/cm² for 0.5 min to 12 hours. Preferably, the heating and pressing step is conducted at a pressure ranging from 10 to 200 kg/cm². By using a pressing pressure of 10 kg/cm² or higher, a sufficient flowability of resin can be achieved while thermally curing to render the resin able to penetrate fabrics to enhance the binding among fibers of fabrics. In addition, pressing at a pressure of 200 kg/cm² or lower will facilitate the release of vapor-generated from the resin to the outside at the time of curing the resin.

In the present invention, the carbonizing step is preferably carried out at a temperature ranging from 1050° C. to 3000° C. During carbonization, the chemical structures of resin and fibers will change, wherein the fibers will convert to carbon fibers and the resin will form a material that has a carbon structure and thus is electrically conductive. Nevertheless, as described hereinbefore, the electric conductivity of the material formed from the,carbonization of resin is less than that of the carbon fibers from the oxidized or pre-carbonized oxidized fibers. In general, a higher carbonization temperature will provide a final product with better electric conductivity.

To avoid ashening fibers during carbonization, it is preferred that the carbonization treatment be conducted in a vacuum or with the protection of an inert gas. For example, the carbonization treatment can be carried out in an inert atmosphere composed of one or more of the following gases: nitrogen, helium and argon. Optionally, the carbonization can, be carried out under a tensionless situation as described above for the pre-carbonization treatment.

Given the above, the porous, carbon electrode substrate of the present invention can also be prepared by a method comprising the following steps:

(a) providing an oxidized fabric;

(b) pre-carbonizing the oxidized fabric;

(c) impregnating the pre-carbonized oxidized fabric with a resin material to provide a resin material-carried fabric;

(d) heating and pressing the resin material-carried fabric; and

(e) carbonizing the heated and pressed fabric.

The details for the selection of the oxidized fabric and the operations of the pre-carbonizing step, impregnating step, heating and pressing step, and carbonizing step, are the same as those described above.

The following examples are provided to further illustrate the present invention. In the examples, the physical values and the like are measured as follows:

A. Density

The density of prepared electrode substrates was measured by a real density meter (Accupyc 1330 Pycnometwr, produced by Micromeritics Instrument Corp.). Samples were dried and put in the container of the meter for weighing. High pressure helium was then introduced into the meter until an equilibrium state was reached. To obtain the average density of samples, the volume of the sample was calculated using the ideal gas equation (PV=nRT).

B. Bending Strength, σ_{b}

The bending strength of the prepared electrode substrates was measured according to ASTM-D790 by using a bending strength testing apparatus CY-6040A8 produced by Chun Yen Testing Machines Co., Ltd., Taiwan). The distance (L) between the supporting points was set at 30 mm, while the load was applied at a strain rate of 0.5 mm/min. The rupture load (Pₘₐₓ) in kgf of the pressing wedge was measured from the start of the application of the load to the moment the samples were ruptured. The bending strength (σ_{b}) in MPa was calculated according to the following equation:

$${σ}_{b} = \frac{3 {P}_{max} L}{2 {bt}^{2}}$$

wherein b: width of a sample (mm); t: height of a sample (mm).

Bending Modulus, E_{b}

The bending modulus of the prepared electrode substrates was calculated according to the following equation:

$${E}_{b} = ( \frac{{L}^{3}}{4 {bt}^{3}} ) ( \frac{P}{δ} )$$

wherein P/δ is the initial slope of the S-S curve, wherein the transverse axis was stress and the vertical axis was strain.

Deflection, δ

Measurement was carried out in accordance with ASTM-D790 by using a bending strength testing apparatus CY-6040A8 produced by (Chun Yen Testing Machines Co. Ltd., Taiwan). The distance (L) between the supporting points was set at 30 mm, while the load was applied at strain rate of 0.5 mm/min. To measure the deflection, the moving distance of the pressing wedge was measured from the start of the application of the load to the moment the samples were ruptured.

Surface Resistivity, ρₛ

The surface resistivity value (ρₛ) of an electrode substrate was defined as the ratio of the voltage to the current along its surface per unit of width of the surface (ρₛ=V/I×R_{CF}, wherein V is in voltage, I is in ampere, and R_{CF} is correction factor). The surface resistivity values of prepared electrode substrates were measured in accordance with JIBS K 7194 by using a surface resistivity meter (Loresta GP Model MCP-T600, produced by (Mitsubishi Chemical Corporation). The prepared electrode substrates were cut into appropriate sizes and their surface resistivity values were directly measured using the surface resistivity meter.

Gas Permeability

Measurement was conducted in accordance with ASTM D737 by using an air permeability tester (TESTEST FX 3300, produced TEXTEST AG CO.), wherein the area of the tested samples was 38 cm².

Porosity (%)

There are two types of porosity regarding materials, i.e., open porosity and close porosity. The porosity referred to herein was open porosity. The open porosity of the prepared electrode substrates was measured according to ASTM D-570. Samples were dried in an oven set at 50±3° C. for 24 hours, then cooled in a dry container. The weights (W₁) of the samples were measured as soon as they were cooled. Thereafter, the samples were put in deionized water for 24 hours, and weighed (W₂) after the water on their surfaces was cleaned off. Porosity (%)=[(W₂−W₁)/W₁]×100%.

### EXAMPLE 1

An oxidized fabric (produced by Challenge Carbon Technology, Taiwan) that was plain woven and had a thickness of 0.73 mm, 21 pitches/inch, 21 rows/inch, and 310 g/m², was immersed in a methanol solution containing 15 wt % of phenolic resin (phenolic resin PF-650 produced by Chang Chun Plastics. Co. Ltd., Taiwan). The resin-carried fabric was dried at 70° C. for 15 minutes, and then heated and pressed at a temperature of 170° C. and a pressure of 10 kg/cm² for 15 minutes to cure the resin to provide a fabric with a resin content of 12.24 wt %. Thereafter, the fabric was heated at 1300° C. in a nitrogen gas atmosphere to carbonize the fabric and provide a porous carbon electrode substrate with a thickness of 0.63 mm. The physical properties of thus prepared substrate were tested and recorded. As shown in Table 1, the porous carbon electrode substrate had a good property combination of gas permeability, bending strength, and electric conductivity.

### EXAMPLE 2

An electrode substrate was obtained in the same manner as EXAMPLE 1 except that the resin content of the-fabric after being heated and pressed was 11.1 wt % and the carbonization treatment was conducted at a temperature of 2500° C. The physical properties of thus prepared substrate were tested and recorded. As shown in Table 1, in addition to the good gas permeability and porosity, the electrode substrate prepared by using a higher carbonization temperature also had better electric conductivity.

### EXAMPLE 3

An electrode substrate was obtained in the same manner as EXAMPLE 1 except that the methanol solution contained 30 wt % of phenolic resin, and the resin content in the fabric after the heating and pressing treatment was 26.0 wt %. The physical properties of thus prepared substrate were tested and recorded. As shown in Table 1, the increase of resin content is advantageous to the bending strength of the prepared porous carbon electrode substrate. The gas permeability and electric conductivity of the prepared electrode substrate were also appropriate.

### EXAMPLE 4

An electrode substrate was obtained in the same manner as EXAMPLE 1 except that the methanol solution also contained 15 wt % of carbon black (carbon black N-660 produced by Korea Steel Chemical Co.). After the heating and pressing treatment, the total content of resin and carbon black of fabric was 11.9 wt %. The physical properties of thus prepared substrate were tested and recorded. As shown in Table 1, the addition of carbon black resulted in a better bending strength and bending modulus in the porous carbon electrode substrate, as well as good gas permeability and porosity.

### EXAMPLE 5

An electrode substrate was obtained in the same manner as EXAMPLE 1 except that the methanol solution also contained 15 wt % of (MCMB) (mesophase pitch powder GCSMB, produced by CHINA STEEL CHEMICAL CORPORATION, Taiwan). After the heating and pressing treatment, the total content of resin and MCMB of fabric was 10.9 wt %. The physical properties of thus prepared substrate were tested and recorded. As shown in Table 1, the addition of MCMB resulted in good deflection, bending strength and bending modulus in the porous carbon electrode substrate, as well as an appropriate gas porosity and electric conductivity.

### EXAMPLE 6

An electrode substrate was obtained in the same manner as EXAMPLE 1 except that an oxidized fabric with a thickness of 0.84 mm, 25 pitches/inch, 21 rows/inch, and 475 g/m² was used. After the heating and pressing treatment, the resin content of fabric was 12.0 wt %. The physical properties of thus prepared substrate were tested and recorded. As shown in Table 1, the prepared porous carbon electrode substrate had good bending strength, electric conductivity, gas permeability, and porosity.

### EXAMPLE 7

An electrode substrate was obtained in the same manner as EXAMPLE 1 except that the resin contained in the methanol solution was a thermoplastic resin (BMI-H/DABPA Polyimide Resin 5292, produced by Ciba-Geigy Chemical Corporation, US). After the heating and pressing treatment, the resin content of fabric was 32.8 wt %. The physical properties of thus prepared substrate were tested and recorded. As shown in Table 1, the prepared porous carbon electrode substrate had good bending strength, electric conductivity, gas permeability, and porosity.

### EXAMPLE 8

An electrode substrate was obtained in the same manner as EXAMPLE 1 except that prior to being immersed in the methanol solution, the oxidized fabric was pre-carbonized at 1000° C. in a nitrogen gas atmosphere to provide a pre-carbonized oxidized fabric with 24 pitches/inch, 24 rows/inch, 275 g/m², a density of 1.9085 g/m³, and a carbon content of 95.43 wt %. After the heating and pressing treatment, the resin content of fabric was 13.2 wt %. The physical properties of thus prepared substrate were tested and recorded. As shown in Table 1, the prepared porous carbon electrode substrate had good bending strength, bending modulus, deflection, electric conductivity, and gas permeability.

### EXAMPLE 9

An electrode substrate was obtained in the same manner as EXAMPLE 1 except that prior to being immersed in the methanol solution, the oxidized fabric was pre-carbonized at 1300° C. in a nitrogen gas atmosphere to provide a pre-carbonized oxidized fabric with 25 pitches/inch, 24 rows/inch, 235 g/m², a thickness of 0.54 mm, a density of 1.5456 g/m³, and a carbon content of 95.57 wt %. After the heating and pressing treatment, the resin content of fabric was 12.9 wt %. The physical properties of thus prepared substrate were tested and recorded. As shown in Table 1, the prepared porous carbon electrode substrate had good bending strength, bending modulus, deflection, electric conductivity, and gas permeability.

### EXAMPLE 10

An electrode substrate was obtained in the same manner as EXAMPLE 1 except that prior to being immersed in the methanol solution (containing 5 wt % of phenolic resin), the oxidized fabric was pre-carbonized at 1000° C. in a nitrogen gas atmosphere to provide a pre-carbonized oxidized fabric with 24 pitches/inch, 24 rows/inch, 240 g/m², a density of 1.9085 g/m³, and a carbon content of 95.43 wt %. After the heating and pressing treatment, the resin content of fabric was 6.8 wt %. The physical properties of thus prepared substrate were tested and recorded. As shown in Table 1, the prepared porous carbon electrode substrate had good bending strength, bending modulus, deflection, electric conductivity, and gas permeability.

### EXAMPLE 11

An electrode substrate was obtained in the same manner as EXAMPLE 1 except that prior to being immersed in the methanol solution, the oxidized fabric was pre-carbonized in an oven as follows: the fabric was first heated under a nitrogen gas atmosphere wherein the temperature in the oven was increased from room temperature to 1000° C. at a rate of 2° C./min and then decreased back to room temperature at a rate of 10° C./min, and then heated under an argon atmosphere wherein the temperature in the oven was increased from room temperature to 2500° C. at a rate of 10° C./min and then decreased back to room temperature at a rate of 10° C./min. The pre-carbonized oxidized fabric thus prepared had a weight of 230 g/m², 24 pitches/inch, 24 rows/inch, a density of 1.7702 g/cm³, and a carbon content of 96.60 wt %. Furthermore, the methanol solution used contained 5 wt % of phenolic resin, and after the heating and pressing treatment, the resin content of fabric was 7.3 wt %. The physical properties of thus prepared substrate were tested and recorded. As shown in Table 1, the prepared porous carbon electrode substrate was so flexible that its bending strength, bending modulus, and deflection were not recordable. The electric conductivity and gas permeability of the prepared substrate were also good.

### COMPARATIVE EXAMPLE 1

An electrode substrate was obtained in the same manner as EXAMPLE 1 except that the carbonization treatment was conducted at a temperature of 600° C. in a nitrogen gas atmosphere, and after the heating and pressing treatment, the resin content of fabric was 12.9 wt %. The physical properties of thus prepared substrate were tested and recorded. As shown in Table 1, the gas permeability and electric conductivity of the prepared porous carbon electrode substrate were poor.

### COMPARATIVE EXAMPLE 2

An electrode substrate was obtained in the same manner as EXAMPLE 1 except that the carbonization treatment was conducted at a temperature of 1000° C. in a nitrogen gas atmosphere, and after the heating and pressing treatment, the resin content of fabric was 11.5 wt %. The physical properties of thus prepared substrate were tested and recorded. As shown in Table 1, the electric conductivity of prepared porous carbon electrode substrate was still poor.

### COMPARATIVE EXAMPLE 3

An electrode substrate was obtained in the same manner as EXAMPLE 1 except that an oxidized fiber felt was used for the preparation of an electrode substrate, wherein the oxidized fiber felt was prepared by needling oxidized polyacrylonitrile (PAN) fibers with a diameter of 13 to 15 μm and a length of 65 mm (oxidized PAN fiber with a limiting oxygen index of from 50 to 60, produced by Toho Rayon Co. Ltd., Japan). After the heating and pressing treatment, the resin content of felt was 3.2 wt %. The physical properties of thus prepared substrate were tested and recorded. As shown in Table 1, the gas permeability of prepared porous carbon electrode substrate was poor.

TABLE 1
Physical Properties of Electrode Substrates of Examples and Comparative Examples

| | | | Bending | Bending | | Surface | Gas | |
|---|---|---|---|---|---|---|---|---|
| | Thickness | Density | Strength, | Modulus, | Deflection, | Resistivity^{a}, | Permeability | Porosity |
| | (mm) | (g/cm³) | σ^{b} (MPa) | E^{b} (MPa) | δ (mm) | ρₛ(Ω/sq) | (cm³/cm²/s) | (%) |
| Ex. 1 | 0.63 | 1.6087 | 1.68 | 22.19 | 1.71 | 0.3546 | 78.9 | 81.15 |
| Ex. 2 | 0.59 | 1.5286 | 0.79 | 31.27 | 0.48 | 0.2219 | 79.6 | 73.58 |
| Ex. 3 | 0.81 | 1.7262 | 2.18 | 16.15 | 2.73 | 0.2456 | 59.1 | 80.17 |
| Ex. 4 | 0.70 | 1.5784 | 2.29 | 42.64 | 1.34 | 0.3231 | 29.0 | 51.24 |
| Ex. 5 | 0.52 | 1.6434 | 10.27 | 82.29 | 4.28 | 0.2590 | 16.5 | 71.53 |
| Ex. 6 | 0.68 | 1.5641 | 1.16 | 20.30 | 1.43 | 0.8590 | 61.7 | 86.20 |
| Ex. 7 | 0.76 | 1.5139 | 2.19 | 20.42 | 2.07 | 0.3610 | 79.0 | 82.44 |
| Ex. 8 | 0.51 | 1.6678 | 9.68 | 78.03 | 5.86 | 0.2388 | 23.6 | 96.85 |
| Ex. 9 | 0.55 | 1.4255 | 9.52 | 70.63 | 5.29 | 0.3824 | 19.0 | 63.30 |
| Ex. 10 | 0.49 | 1.4668 | 13.92 | 151 | 5.57 | 0.2650 | 42.5 | 51.20 |
| Ex. 11 | 0.42 | 1.4988 | * | * | * | 0.2437 | 47.4 | 60.30 |
| Comparative Ex. 1 | 0.54 | 1.8775 | 2.26 | 24.70 | 2.34 | 4506000 | 22.7 | 55.80 |
| Comparative Ex. 2 | 0.59 | 1.4374 | 2.21 | 29.07 | 1.86 | 5.0020 | 65.3 | 89.96 |
| Comparative Ex. 3 | 0.67 | 1.8842 | 9.24 | 291.44 | 2.11 | 0.2910 | 9.3 | 62.23 |

Note
^{a}the surface resistivity (Ω/sq, Ω/□) is irrelevant to the size of the tested square
^{b}the bending strength, bending modulus and deflection of the electrode substrate prepared in Example 11 were not recordable because it was too flexible to be ruptured during the testing procedure

As illustrated by the examples above, the electrode substrates prepared using the method of the present invention have a suitable combination of gas permeability, porosity, bending strength, and surface resistivity, without the shortcoming of non-uniform electric conductivity possessed by the electrode substrates prepared from short carbon fibers.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A porous carbon electrode substrate with a woven structure and having a property combination of a thickness ranging from 0.1 to 1.0 mm, a bending strength of 0.7 MPa or more, a porosity of 50% or more, and a surface resistivity of 1.0Ω/sq or less.

2. The porous carbon electrode substrate of claim 1, wherein the substrate is for use in a fuel cell.

3. The porous carbon electrode substrate of claim 2, wherein the fuel cell is a solid polymer fuel cell or a direct methanol fuel cell.

4. A method of preparing the porous carbon electrode substrate of claim 1 comprising the following steps:
(a) providing a fabric that is an oxidized fabric or a pre-carbonized oxidized fabric,
(b) impregnating the fabric with a resin material to provide a resin material-carried fabric,
(c) heating and pressing the resin material-carried fabric, and
(d) carbonizing the fabric after the heated and pressed fabric.

5. The method of claim 4 wherein the thickness of the fabric in step (a) is from 0.1 to 1.0 mm.

6. The method of claim 4 wherein the fabric in step (a) is an oxidized fabric having a limiting oxygen index of 40 or more.

7. The method of claim 4 wherein the fabric in step (a) is an oxidized fabric prepared by thermal treatment of a fabric composed of one or more of the following materials: polyacrylonitrile fibers, asphalt fibers, phenolic fibers, and cellulose fibers.

8. The method of claim 4 wherein the fabric in step (a) is a pre-carbonized oxidized fabric obtained by treating an oxidized fabric at a temperature ranging from 600 to 3000° C., and the oxidized fabric has a limiting oxygen index of 40 or more.

9. The method of claim 4 wherein the fabric in step (a) is a pre-carbonized oxidized fabric having a carbon content of at least 55 wt % and a density of more than 1.5 g/cm³.

10. The method of claim 4 wherein the fabric in step (a) is an oxidized fabric and the method further comprises a step of pre-carbonizing the oxidized fabric before carrying out step (b).

11. The method of claim 4 wherein the resin material in step (b) comprises a resin selected from the group consisting of phenolic resin, furan resin, polyimide, and polyamide.

12. The method of claim 11 wherein the resin is a phenolic resin.

13. The method of claim 11 wherein the resin material further comprises from 0.1 to 50 wt % of an electric conductive substance, based on the total weight of the resin material.

14. The method of claim 13 wherein the resin material comprises from 0.1 to 20 wt % of the electric conductive substance.

15. The method of claim 13 wherein the electric conductive substance is selected from the group consisting of carbon black, acetylene black, graphite powder, carbonaceous milled fiber, isotrophic graphite powder, vapor-grown carbon fiber, nano-carbon tube, mesophase pitch powder, and combinations thereof.

16. The method of claim 4 wherein the fabric obtained from step (c) has a resin content of from 0.01 to 40 wt %.

17. The method of claim 4 wherein the heating and pressing step (c) is carried out at a temperature of from 70 to 320° C. and a pressure of from 1 to 200 kg/cm².

18. The method of claim 4 wherein the carbonization treatment of step (d) is carried out at a temperature of from 1050° C. to 3000° C.

19. The method of claim 4 wherein the carbonization treatment of step (d) is carried out in vacuum or under an inert atmosphere.

20. The method of claim 19 wherein the inert atmosphere is composed a gas selected from the group consisting of nitrogen, helium, argon, and combinations thereof.
